(19) United States
(12) Patent Application Publication
(10) Pub. No.: US 2007/0027413 A9
(43) Pub. Date: Feb. 1, 2007

(54) Piece of furniture comprising a massage unit

(76) Inventor: Dietmar Koch, Lontzen (BE)

Correspondence Address: Steven J Grossman;Grossman Tucker Perreault & Pfleger, 55 South commercial Street, Manchester, NH, 03101, US

(21) Appl. No.: 10/514,213

(22) PCT Filed: May 9, 2003
(86) PCT No.: PCT/DE03/01490

§ 371 Date: Jan. 30, 2006

(30) Foreign Application Priority Data
May 10, 2002 (DE) 202073793

(51) Int. Cl. A61H 7/00

(52) U.S. Cl. 601/99; 601/98; 601/102; 601/103

(57) ABSTRACT

The invention relates to a piece of furniture comprising an integrated massage unit. A supporting surface is disposed on said piece of furniture between a body that leans thereagainst and the massage unit. The massage unit comprises at least one massage body. In order to improve the massaging effect and make the massage feel neither too vigorous nor too weak in the user's subjective perception in any adjusted position of the massage unit regardless of the force that is exercised by leaning thereagainst, a support element (10) backing the body relative to the massage body (5) is disposed on the side of the supporting surface (3), which lies opposite the body, in the area of the massage body (5). Said support element (10) is adjustable in such a way that a vertical movement component allowing depth adjustment is created, the vertical movement being in relation to the supporting surface (3).

The invention relates to a piece of furniture comprising an integrated massage unit, where a supporting surface is disposed on said piece of furniture between a body that leans there-against and the massage unit, and the massage unit comprises at least one massage body. A piece of furniture of this kind can, for example, be a chair, a recliner, a bed, a mattress or the like.

Pieces of furniture of this kind with an integrated massage unit are sufficiently known and serve to massage the body of a person on the piece of furniture in that the massaging units exert forces on the body by means of pulsating, rotary and/or kneading movements. The provision of pieces of furniture with massage units of this kind is known, for example, from DE 297 07 596, DE 195 05 445 or DE 94 19 742. In this context, the massage units are integrated in the corresponding piece of furniture in such a way that they can be moved along a predefined travel path that is governed by the part of the body to be massaged.

With known pieces of furniture comprising massage units, it can happen that a person leaning against the piece of furniture and its upholstery with the full weight of their body, or a part of their body, may perceive the massage as being unpleasant, especially if it does not take place uniformly for anatomical reasons.

The object of the invention is thus to develop a piece of furniture with a massage unit in such a way that its massaging effect is improved and the massage feels neither too vigorous nor too weak in the user's subjective perception in any adjusted position of the massage unit, regardless of the force that is exerted by leaning thereagainst.

According to the invention, the object is solved by a piece of furniture of the kind mentioned in the opening paragraph, in which, in the area of the massage body, a support element backing the body relative to the massage body is located on the side of the supporting surface facing away from the body, and in that the support element is adjustable in such a way that a movement component perpendicular to the supporting surface is created, allowing depth adjustment. In this way, a part of the body located on the piece of furniture and to be massaged is supported optimally and comfortably without the force exerted by the massage unit, and thus the effectiveness of the massage, being restricted. In addition, the provision of the support element prevents part of the supporting effect to be applied against the load imposed by the body having to be exerted by the massage unit, which is actually intended for massaging, if it is not provided sufficiently by the upholstery or the frame.

The support element is advantageously developed by providing a drive unit, meaning that the user of the piece of furniture in question can exactly adjust the support in accordance with their personal requirements and preferences.

In this context, the drive unit is preferably designed as a linear drive that adjusts the support element in a plane of motion located essentially perpendicularly to the supporting surface. This is a simple way of ensuring that the support element is driven and displaced exactly into the appropriate position, and that the massage unit exerts the correct pressure and thus the desired effect on the part of the body located opposite to it as a result of the associated depth positioning of the part of the body to be massaged. Since the massage unit develops its normal, intended effect in this way, and does not additionally work against part of the body weight of the user of the piece of furniture, the user perceives the massage as being pleasant and relaxing.

Instead of a linear drive, a rotary drive is equally open to consideration, the rotary motion of which can be transformed into linear motion by means of a suitable conversion device, e.g. in the form of an eccentric or a toggle lever.

In a preferred embodiment, the support element is designed in the form of a bow, essentially extending along the supporting surface, which is mounted in bearings in a manner adapted to the motion of the support element. In the simplest case, it thus suffices to design the bow in the manner of a rod that is located behind the supporting surface and whose bearing arrangement permits motion relative to the supporting surface. However, it is also conceivable for the shape of the bow to cater to anatomical conditions of parts of the body to be supported from the outset.

To realize the mobility of the support element by simple means, provision can be made in a development for the bow to be connected in pivoting fashion to the drive unit in the area of its one end and to a guide rod in the area of its other end. In the event of movement of the bow by means of the drive unit, the end of the bow facing towards the drive unit thus performs motion about a bearing point located on the other end of the bow, where the length of the bow sweeps over a certain angular range.

In this context, it is furthermore desirable for the support element to be made of an elastic material. The support element is indeed intended to support parts of the body, but excessively rigid support would be more likely to detract from the well-being of the user again, this being the reason why the support element display a certain degree of resilience.

In a special embodiment, the bow can also be designed as a flexible strip that is capable of adapting to the anatomical conditions of the part of the body in question.

To optimally ensure the comfort of the respective user, it is particularly advantageous if the longitudinal extension of the support element corresponds at least to the travel path of the massage unit. In this way, the massage unit can be supported by the support element not only in certain areas, but at every point to which it can be moved for massaging. If, for example, there was a wish to design the support element with a shorter longitudinal extension for reasons of space, it could be designed to be movable along the supporting surface together with the massage unit.

In a development of the invention, it is advantageous that the massage unit displays several, horizontally arranged massage bodies, between which at least one support element is arranged at a distance from the massage bodies. In the interests of optimum support of the area to be massaged, one support element is provided between every two massage bodies in this case. If the support elements are bows with a longitudinal extension along the supporting surface, the massage bodies of the massage unit are moved along the bows.

In order to cater to certain anatomical conditions, it can be of advantage to design at least a section of the side of the support element facing towards the supporting surface in curved form. This is conceivable, for example, in the case of therapeutic applications (lordosis support).

In an advantageous development, the support element can be designed as a support roller mounted in bearings on an axle. In this context, the part of the body to be supported is supported precisely in the area where massage is to take place, for which reason the support roller is designed to be movable along the path of the massage unit. Together with its drive unit provided for depth adjustment, the support roller is then optimally moved in synchrony with the massage unit. In this context, the movement of the support roller in synchrony with the massage unit can take place in the direction of movement of the massage unit and, additionally, with a movement component perpendicular to the supporting surface. This has the advantage that the support device can be adapted to the respective depressions and elevations of the section of the body to be massaged. In this context, the two movements, that of the massage unit and that of the support device, can be coupled electrically, for example, with the help of signal transmitters and/or with the help of a computer program that controls the massage unit and the support device synchronously on the basis of the entered or measured topography of the part of the body to be treated. Also conceivable are mechanical signal transmitters, e.g. in the form of a spring-mounted measuring wheel or measuring ball acting on the surface of the part of the body to be massaged, the movement component of which that is perpendicular to the supporting surface being transmitted to the massage unit and/or the support device by, for example, a set of gears, an eccentric or the like. In this way, the movement of the massage unit and/or the support element can, for example, be controlled and synchronized in relation to the curvature of a spinal column.

Furthermore, a development of the invention is proposed, in which the support element is designed in the form of a slide, the convex side of which lies against the supporting surface in a manner permitting movement along the supporting surface, where the bow is preferably mounted in bearings in a manner permitting pivoting about an axis located horizontally and parallel to the supporting frame. In a development of the invention, it is conceivable that the slide is additionally mounted in bearings in a manner permitting pivoting about an axis located vertically and parallel to the supporting frame. This can be achieved using a ball-and-socket joint, for example. Advantageous in this context is the large potential contact surface of the slide on the supporting surface, which can be adjusted via the slide dimensions, as well as the possibility, offered by the pivoting design of the slide, of adjusting the inclination of the slide to the local inclination of the area of the body to be massaged.

Like the support roller described above, the slide can likewise optimally be arranged to be movable in synchrony with the massage unit, where the synchronous movement can take place along the path of the massage unit and, additionally, with a movement component perpendicular to the supporting surface. To this end, the slide movable with a movement component perpendicular to the supporting surface and the massage unit can, for example, be mounted on a common, movable base.

As regards the above-mentioned resilience of the support element, it is of advantage if the support roller displays a layer of elastic material on its circumference. This can consist, for example, of foamed material or another elastic material. Provided with this layer of material, the roller itself can be made of a rigid material, although it is also possible for it to be designed entirely of elastic material.

The same applies in connection with the above-mentioned design of the support element as a slide, in that the side facing towards the supporting surface can be upholstered with an elastic and, if necessary, skin-compatible layer.

In a further embodiment, a load-bearing element for supporting the support element, and movable parallel to it, is advantageously located on the side of the support element facing away from the supporting surface of the piece of furniture. Given flexible mounting of the support element, such as a bow, the load-bearing element, which can be a roller, for example, supports the support element in the area of the part of the body to be massaged. In this context, the drive unit for depth adjustment is mounted on the load-bearing element, which guides the flexibly mounted support element into the required position. In this context, the load-bearing element reaches through between the massage bodies and acts on the support element.

In a development, the load-bearing element is particularly advantageously designed in the form of a roller, which is mounted in bearings on an axle and acts on the support element. In this way, the load-bearing element can be moved along the support element without having to surrender its supporting effect. Particularly preferably, the roller displays a circumferential groove, in which the support element is guided, meaning that it runs in the groove. Conversely, provision can also be made for the load-bearing element to engage a groove provided on the support element, itself being guided in this groove. In addition, it is also conceivable for the load-bearing element to be connected to the support element in some other manner in such a way that optimum guidance is guaranteed.

Likewise preferred is the design of the load-bearing element as a slide of the above-mentioned type that can be guided along the support element. In this context, the support element can, as previously mentioned above, preferably be designed as a flexible strip, against the side of which facing away from the supporting surface the slide lies in movable fashion. In this context, the slide can, as described above, be mounted in bearings permitting pivoting about at least one axis. In a development, the slide can have a flattened shape, similar to a mushroom head. Furthermore, the strip can display upholstery on the side facing towards the supporting surface. The feeling of well-being of the user is catered to in both cases.

It is generally attributable to the scope of the invention that the support element and/or the load-bearing element and the massage unit can be located in a plane parallel to the supporting surface and perpendicular thereto in a manner permitting movement independently of each other and/or together in synchrony. If several massage units are used, it is conceivable that they are arranged in a manner permitting movement independently of each other and also together in synchrony, as well as independently of, and also in synchrony with, the support element and/or the load-bearing element. As a result, the movement can be optimally adjusted and controlled to suit the kind of massage or passive movement of parts of the body, as well as the topography of the parts of the body in question.

In this case, however, the load-bearing element is preferably connected to the massage unit and movable in synchrony with it. The result of this is that, in the area of the body in which the massage bodies of the massage unit are intended to develop their effect, the support element can be supported by the load-bearing element, whose depth can be adjusted by the drive unit.

Furthermore, a development of the invention is proposed, in which the support element and/or the load-bearing element, in the form of a support roller or in the form of a slide, can be positioned and moved with a movement component perpendicular to the supporting surface in such a way that they project beyond the massage bodies in relation to the supporting surface. As a result of the movement of the support element and/or the load-bearing element over the part of the body to be treated, said part of the body can be moved via the movement component perpendicular to the supporting surface without independent activity of the part of the body, for example in the form of passive movement of the spinal column.

Obviously, a combination is also conceivable in which the part of the body to be treated can be passively moved and massaged by positioning the support elements and/or the load-bearing elements in relation to the massage unit, in that their movement components perpendicular to the supporting surface take place in synchrony.

In a further embodiment, the support element is arranged to extend flexibly along the supporting surface and to be braced between the areas of its ends. This means that the support element can adapt to the contour defined by the supported part of the body and by the supporting surface. In this context, the support element is braced more weakly or more strongly between its ends, depending on the desired supporting effect.

In an advantageous development, the support element is a tensioning bar in the manner of a belt, which can be arranged and braced particularly flexibly. In this context, the belt can, for example, be guided on rollers and can then be taken up on at least one of the rollers, meaning that slacker or tauter belt tension is encountered, depending on the progress of take-up. This kind of support could additionally also be achieved by externally controllable tautening of the upholstery in different segments.

In another embodiment, the support element can be conceived as a net, against which the supporting surface rests on one side, and the massage unit, as well as a further support element and/or load-bearing element, on the other side.

Several practical examples of the invention are explained in more detail below on the basis of the Figures in the drawing. The Figures show the following:

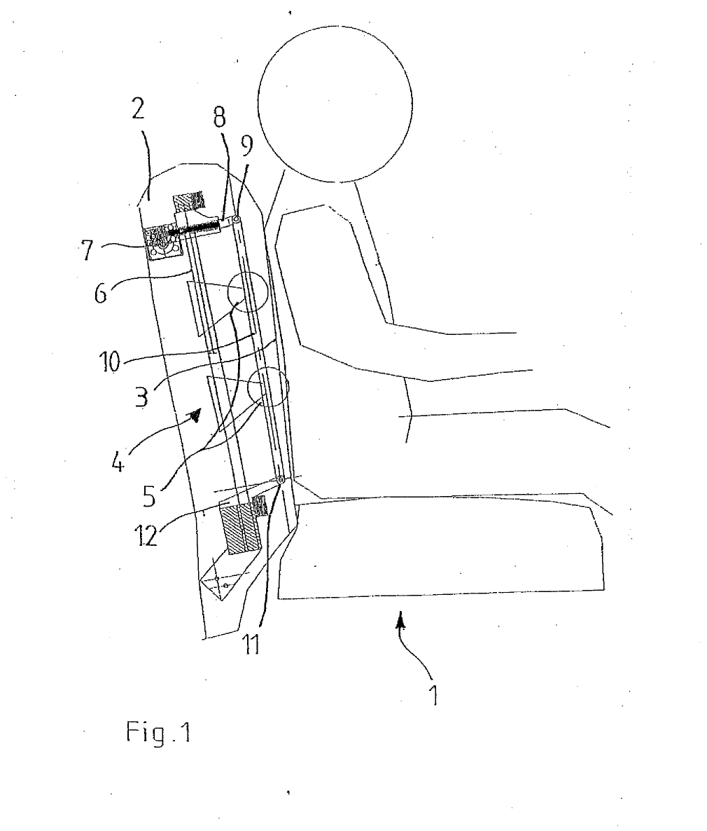

FIG. 1 A first embodiment of the invention, with a piece of furniture comprising a massage unit, on which a bow-like support element with drive unit is located;

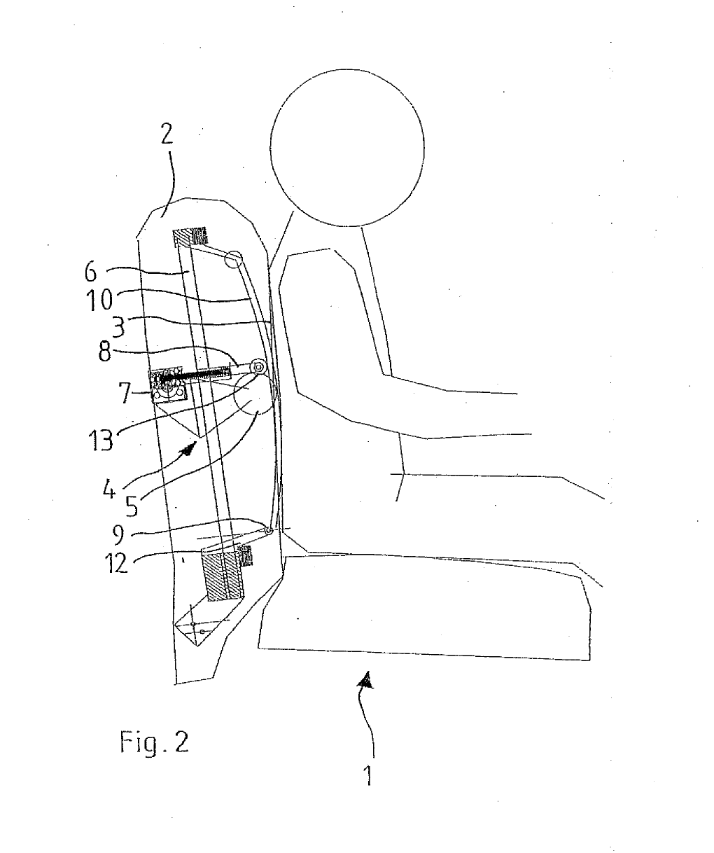

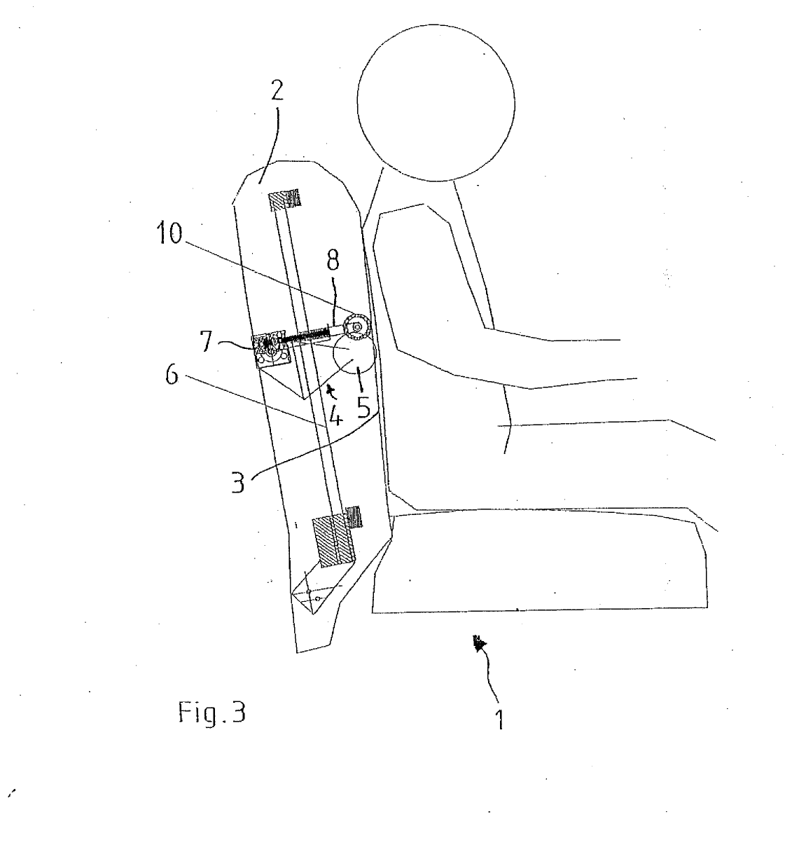

FIG. 2 A further embodiment of the invention, with a bow-like support element and a load-bearing element;

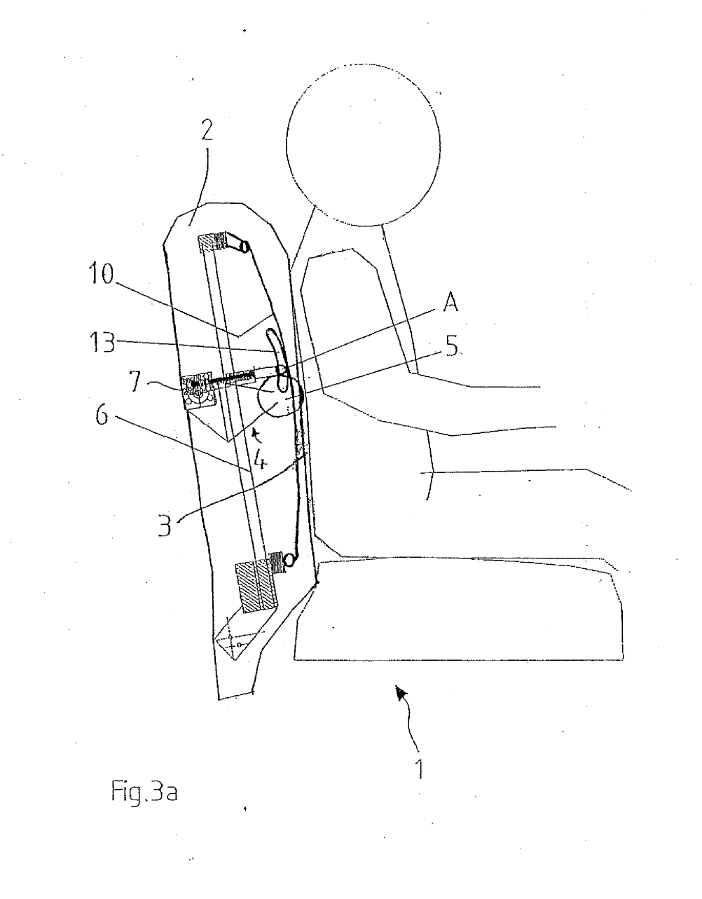

FIG. 3 A third embodiment of the invention, where the support element displays the form of a roller;

FIG. 3a A fourth embodiment of the invention, where the load-bearing element displays the form of a slide;

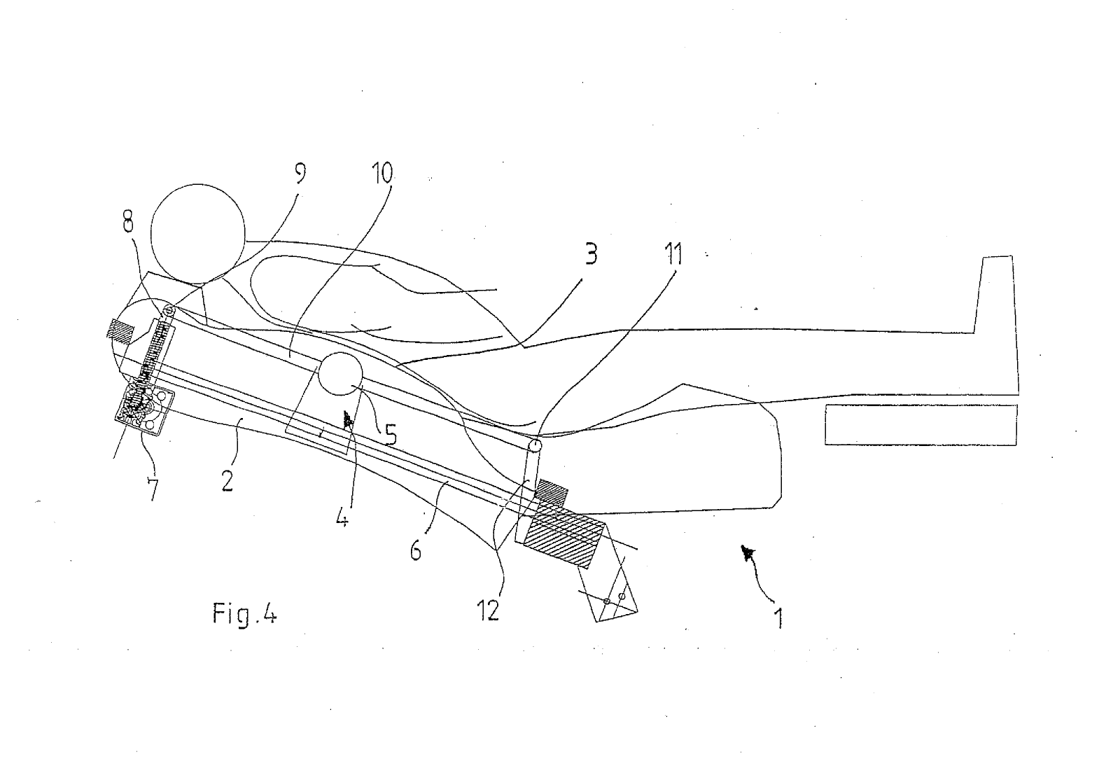

FIG. 4 A different position of the piece of furniture of the embodiment illustrated in FIG. 1, and

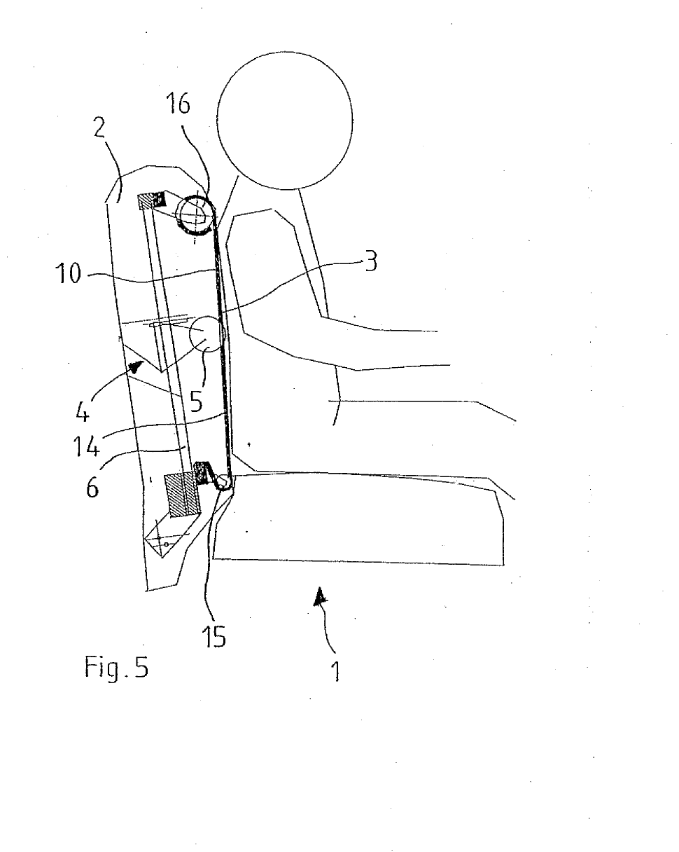

FIG. 5 A further embodiment of the invention, where the support element is formed by a belt-like tensioning bar.

FIG. 1 shows a piece of furniture comprising a massage unit, where the piece of furniture is chair 1 with seat and backrest 2, on which a person is sitting. In this context, the back of the person is opposite supporting surface 3 of backrest 2 of chair 1, leaning against it, and can be treated by being massaged by massage bodies 5 of massage unit 4 of chair 1.

Located in backrest 2 of chair 1 is guide frame 6 of massage unit 4, along which massage unit 4 can be moved on a travel path between an upper and lower adjustment position. In this context, FIG. 1 shows two different positions of massage bodies 5 for massaging various areas of the body located on the piece of furniture. Located at the upper end of guide frame 6 is linear drive 7, in retracted state, which drives rod 8, which is connected, via link joint 9, to the upper end of a bow forming support element 10. Located at the lower end of the latter is a further link joint 11, which leads back towards guide frame 6 via rigid leg 12. If drive 7 moves rod 8 in the direction of supporting surface 3, support element 10 performs a pivoting movement about link joint 11, and the part of the body leaning against supporting surface 3 is supported more strongly or moved away from massage body/bodies 5. The effect of the massage bodies on the part of the body to be massaged becomes weaker as a result, increasing again when the direction of the drive unit is reversed. On the whole, the leaning person can thus individually adjust the desired effect of massage bodies 5 by means of support element 10 provided with drive 7.

In principle, FIG. 2 shows the same arrangement of a body leaning against chair 1. In this context, backrest 2 of chair 1 shown again displays support element 10, located between guide frame 6 and supporting surface 3, in the form of a flexible bow. In this case, support element 10 itself is not provided with a drive, its end areas instead being connected to the upper and lower end of guide frame 6 in articulated fashion. Located roughly at the height of the massage roller is linear drive 7, which guides rod 8 with a movement component perpendicular to supporting surface 3. Located on the free end of rod 8 is load-bearing element 13, which acts supportively on the side of support element 10 facing away from supporting surface 3 and, in this context, reaches through the gap between the two massage bodies 5, of which only the one that faces towards the viewer is visible. At the same time, load-bearing element 13 is connected to support element 10 in that the former runs in a groove (not shown) in the latter. The action of load-bearing element 13 on flexible support element 10 curves the latter in the direction of supporting surface 3. Since drive 7 is designed to move in synchrony with massage bodies 5, designed as massage rollers, and support element 10 is flexible, the body is supported by support element 10 and load-bearing element 13 is precisely the area in which a massage is to take place. In the condition shown, the extended state of rod 8 and the associated supporting effect result in massage bodies 5 having only a slight massaging effect, which can be increased as required by retracting the load-bearing element.

FIG. 3 shows a third embodiment, where support element 10, which is located in backrest 2 of chair 1, itself consists of a roller. The situation essentially corresponds to that illustrated in FIG. 2, the difference being that not load-bearing element 13 is located on the free end of rod 8, driven by drive 7, but support element 10. In this context, the circumference of the roller forming support element 10 is provided with elastic layer 14, this benefiting greater flexibility. Drive 7 is again designed to be movable in synchrony with massage unit 4, meaning that the rod and, in this case, the support element again reach through the gap between massage bodies 5.

FIG. 3a illustrates a fourth embodiment, which largely corresponds to that shown in FIG. 2. The difference here is that load-bearing element 13 is designed as a slide, which is mounted in bearings at pivoting point A in a manner permitting pivoting about a horizontal axis. In this context, load-bearing element 13 and massage unit 4 with massage bodies 5 can, as indicated by the proximity of the two elements in the diagram, be moved in synchrony with each other and in a plane parallel to the plane spanned by guide frame 6. To this end, the slide and the massage unit can, for example, be mounted together on a movable base not shown here. In addition, as schematically illustrated by drive 7, additional, mutually independent movement of massage bodies 5 and slide 6 is conceivable, this displaying a movement component perpendicular to supporting surface 3 and allowing depth adjustment.

In FIG. 3a, the slide is shown as being mounted eccentrically at pivoting point A. Obviously, for easier pivoting of the slide, it is conceivable for the slide to be mounted in the area of the center of gravity of the slide. Moreover, deviating from FIG. 2, support element 10 is designed as a flexible strip, where the rounded side of the slide contacts the side of the strip facing away from the supporting surface in movable fashion. As not illustrated in the drawing here, the side of the flexible strip facing towards the supporting surface can display upholstery for the comfort of the user.

FIG. 4 shows the embodiment in FIG. 1 in a different position. In this context, backrest 2 has been pivoted in relation to the seat of chair 1 in such a way that the body of a person resting on it assumes a more horizontal, lying position. In this position, a major portion of the weight of the person weighs on supporting surface 3, rather than only leaning against it in the upright position. In order to be able to guarantee effective and pleasant massaging of the required parts of the body by massage unit 4, even when the piece of furniture is exposed to this pressure, the supporting effect is, as already illustrated in FIG. 1, applied by support element 10 in the form of a strip. In this context, driven by drive 7, the position of the support element can be adjusted individually, so that massage bodies 5 of massage unit 4 can develop precisely the desired massaging effect in every area to be massaged.

Finally, FIG. 5 shows a further embodiment of the piece of furniture according to the invention with an alternative design of support element 10. As in FIGS. 1 to 4, the person using the piece of furniture is again leaning against supporting surface 3 in sitting position. However, on the side of supporting surface 3 facing away from the person, belt 14 is now provided as support element 10, running between the upper and lower end of guide frame 6. Starting from its lower fastening point in the area of the lower end of guide frame 6, belt 14 first runs around guide roller 15 and then essentially parallel along supporting surface 3, then ending on a take-up roller located at the upper end of guide frame 6. Belt 14 is fastened there in such a way that it is wound or unwound when take-up roller 16 rotates about its axis, this leading to tautening or relaxation of the belt tension. In the case illustrated, massage unit 4 with its massage bodies 5 develops only a slight effect because of the strong tautening of belt 14.

### LIST OF REFERENCE NUMBERS

1 Chair
2 Backrest
3 Supporting surface
4 Massage unit
5 Massage body
6 Guide frame
7 Drive unit
8 Rod
9 Link joint
10 Support element
11 Link joint
12 Leg
13 Load-bearing element
14 Belt
15 Guide roller
16 Take-up roller
A Pivoting point

1. Piece of furniture comprising an integrated massage unit, where a supporting surface is disposed on said piece of furniture between a body to be leaned thereagainst and the massage unit, and the massage unit comprises at least one massage body, characterized in that, in the area of the massage body, an additional support element backing the body relative to the massage body is located on the side of the supporting surface facing away from the body, and in that the support element is adjustable in such a way that a movement component perpendicular to the supporting surface is created, allowing depth adjustment.

2. Piece of furniture according to claim 1, characterized in that a drive unit is provided for adjustment of the support element.

3. Piece of furniture according to claim 2, characterized in that the drive unit is designed as a linear drive that adjusts the support element in a plane of motion located essentially perpendicularly to the supporting surface.

4. Piece of furniture according to claim 1, characterized in that the support element is designed in the form of a bow, essentially extending along the supporting surface, which is mounted in bearings in a manner adapted to the motion of the support element.

5. Piece of furniture according to claim 4, characterized in that the bow is connected in pivoting fashion to the drive unit in the area of its one end and to a guide rod in the area of its other end.

6. Piece of furniture according to claim 4, characterized in that the support element is made of an elastic material.

7. Piece of furniture according to claim 1, characterized in that the massage unit displays several, horizontally arranged massage bodies, between which at least one support element is arranged at a distance from the massage bodies.

8. Piece of furniture according to claim 4, characterized in that at least a section of the side of the support element facing towards the supporting surface is designed in curved form.

9. Piece of furniture according to claim 1, characterized in that the support element is designed as a support roller mounted in bearings on an axle.

10. Piece of furniture according to claim 9, characterized in that the support roller displays a layer of elastic material on its circumference.

11. Piece of furniture according to claim 1, characterized in that a load-bearing element for supporting the support element, and movable parallel to it, is located on the side of the support element facing away from the supporting surface of the piece of furniture.

12. Piece of furniture according to claim 11, characterized in that the load-bearing element is designed in the form of a roller, which is mounted in bearings on an axle and acts on the support element.

13. Piece of furniture according to claim 11, characterized in that the load-bearing element is connected to the massage unit and movable in synchrony with it.

14. Piece of furniture according to claim 1, characterized in that the support element is arranged to extend flexibly along the supporting surface and to be braced between the areas of its ends.

15. Piece of furniture according to claim 14, characterized in that the support element is a tensioning bar in the manner of a belt.
